(19) United States
(12) Patent Application Publication
(10) Pub. No.: US 2004/0264302 A1
(43) Pub. Date: Dec. 30, 2004

(54) System and method for synchronizing a parking meter clock

(76) Inventor: Seth Ward II, Little Rock, AR (US)

Correspondence Address: CONLEY ROSE, P.C., 5700 GRANITE PARKWAY, SUITE 330, PLANO, TX, 75024, US

(21) Appl. No.: 10/602,306

(22) Filed: Jun. 24, 2003

(51) Int. Cl. G04F 1/00; G04F 3/00

(52) U.S. Cl. 368/90

(57) ABSTRACT

A system and method for synchronizing a parking meter clock is provided. The system includes a parking meter having a clock and an antenna coupled to the parking meter for receiving a wireless broadcast data including a time data. The parking meter further provided with a receiver and an interface. The receiver communicates with the antenna to demodulate the wireless broadcast data received by the antenna and the interface communicates with the receiver to communicate the wireless broadcast data to synchronize the clock on the parking meter. A method of synchronizing a clock on one or more parking meters is also provided that includes receiving a wireless broadcast data including a time-of-day data. The method further includes updating the clock on the parking meter based on the wirelessly broadcast data. In one aspect, the time-of-day data is based on an atomic clock.

### TECHNICAL FIELD OF THE INVENTION

This invention relates generally to the field of parking meters and more particularly, but not by way of limitation, to a system and method for synchronizing a clock on a parking meter.

### BACKGROUND OF THE INVENTION

Electronic parking meters feature quartz crystals and real-time clocks, enabling them to change to different parking rates and meter modes, such as power saving off mode, at different times of the day, week, and year. Such features, however, require proper synchronization of the clocks in the parking meter, or system or population of parking meters, to avoid confusion for motorists and parking enforcement personnel.

The synchronization of the parking meter clocks has been achieved with inadequate results by the use of hand-held communication devices having their own internal clocks, which are set by downloading from a personal computer, or manually. Individuals responsible for maintaining the meter physically transport the hand-held computers or communication devices to the back of the parking meters and connect to the parking meter via a serial cable or other means, such as infrared communications. It is readily apparent that such a system is wrought with inefficiencies causing the clocks on the parking meter to not be timely or uniformly updated, or to update the clocks on the parking meter with inaccurate date and time information.

Accordingly, a need exists for an improved system and method for synchronizing clocks on one or more parking meters.

### SUMMARY OF THE INVENTION

Based on the deficiencies with the prior systems for updating parking meter clocks, the present invention provides a system that enables a parking meter to retrieve and adjust the clocks on the parking meters automatically from a common signal, providing a dramatic improvement in accuracy and efficiency for synchronizing clocks on parking meters. As such, the present invention maximizes the efficiency of the parking meter and avoids misunderstanding and frustration in the use of parking meters and the enforcement of parking meters during rate or mode changes, or when daylight savings time occurs, for example.

According to one aspect of the present invention, an electronic parking meter is provided with a means to receive a signal, such as a wireless signal having a time information based on an atomic clock, and synchronize a real-time clock in the parking meter based on the signal. According to one aspect, the signal is a radio signal, while in other aspects, the signal may be a time reference generated by a television signal, while in other aspects the signal may be a wireless signal obtained from a wireless Internet connection having a time information based on a standard measurement device, such as atomic clock.

According to one aspect, the parking meter is operable to receive an AM radio signal from the NIST's (National Institute of Standards) radio station WWVB that broadcasts a highly accurate time generated by an atomic clock, which may be maintained by governmental or other authority or business. In one aspect, the present invention is operable to receive a signal from a time standards authority in the United States, while in other aspects the parking meter of the present invention is operable to receive a signal from other authorities or other governmental entities.

In some aspects, the parking meter is operable to obtain a time reference from a television signal, such as VHF. In other aspects, the parking meter is operable to communicate with a wireless network, such as WiFi network, such as by using Blue Tooth or other wireless functionality, to obtain data from the USNO (United States Naval Observatory) via a wireless Internet connection, as other examples which are within the spirit and scope of the present invention.

According to one aspect, the present invention provides a parking meter having a processor to process parking-related information and a clock communicating with the processor to maintain time and/or data information. The parking meter is further provided with an antenna coupled to the parking meter for receiving a wireless broadcast and a receiver communicating with the antenna to demodulate the wireless broadcast data received by the antenna. An interface is provided, in one aspect, which communicates with the receiver to communicate the wireless broadcast data to synchronize the clock.

According to one aspect, the antenna is a ferrite antenna, while in other aspects the antenna is a trace on a printed circuit board coupled to the parking meter. In other aspects, other appropriate antennas may be used based on the signal transmitted, which are within the spirit and scope of the present invention. In one aspect, the wireless broadcast data is an AM signal and the receiver is defined as an integrated circuit for receiving and demodulating the AM signal.

According to another aspect, the present invention provides a method of synchronizing a clock on a parking meter. The method includes receiving a wirelessly broadcast data that includes a time-of-date data. The parking meter may be operative to receive the signal at a convenient time, such as in the early morning or during mode or rate transition periods. The method further provides for updating the clock on the parking meter based on the wirelessly broadcast data. In some aspects, the time-of-date data is based on the atomic clock, while in other aspects the time-of-date data is based on other standard and highly-accurate time measurement devices.

In another aspect, the present invention provides a method of synchronizing time circuits on a plurality of parking meters. The method includes broadcasting a time signal including a time-of-day data. The method further provides for receiving the time signal by a plurality of parking meters and synchronizing a clock on one or more of the plurality of parking meters based on the time signal. According to one aspect, the time signal is an AM broadcast of a time generated based on an atomic clock. According to other aspects, the time signal is a reference is provided by a television signal, while in other aspects, the time signal is obtained via a wireless Internet connection.

According to some aspects, the present invention provides a parking meter having a housing, a payment slot coupled to the housing to receive payment for parking, and a processor in communication with the payment slot. The parking meter includes a display communicating with the processor to display a parking information based on payment received via the payment slot. The parking meter further includes a clock communicating with the processor to maintain a time information for use by the parking meter. The parking meter further includes an antenna, a receiver, and an interface. The antenna is provided to receive a wireless broadcast time data and the receiver demodulates the wireless broadcast time data. The interface is coupled to communicate the wireless broadcast time data to synchronize the clock.

According to one aspect, the payment receiving slot is a card reader to receive a smart card, while in other aspects the card reader is operable to receive a credit card or other cards having a magnetic stripe. According to another aspect, the payment slot is defined as a coin chute provided for receiving coins and, in the this aspect, the parking meter further includes a coin box coupled to the coin chute for retaining coins.

Other objects, features, and advantages the present invention will be apparent to those skilled in the art from the following detailed description when read in conjunction with the accompanying drawings and claims.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts in which:

FIG. 1 is a diagrammatic illustration of one aspect of the present invention of a system for synchronizing a parking meter clock, with the parking meter shown in a partial cutaway;

FIG. 2 is a perspective view of a ferrite antenna according to one aspect of the antenna utilized by the present invention;

FIG. 3 is a diagrammatic illustration of part of a parking meter showing the location of the antenna, according to one aspect of the present invention;

FIG. 4 is a diagrammatic illustration of part of a parking meter showing another position of the antenna, according to another aspect of the present invention; and

FIG. 5 is a flowchart of a method for synchronizing a parking meter clock, according to another aspect of the present invention.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein.

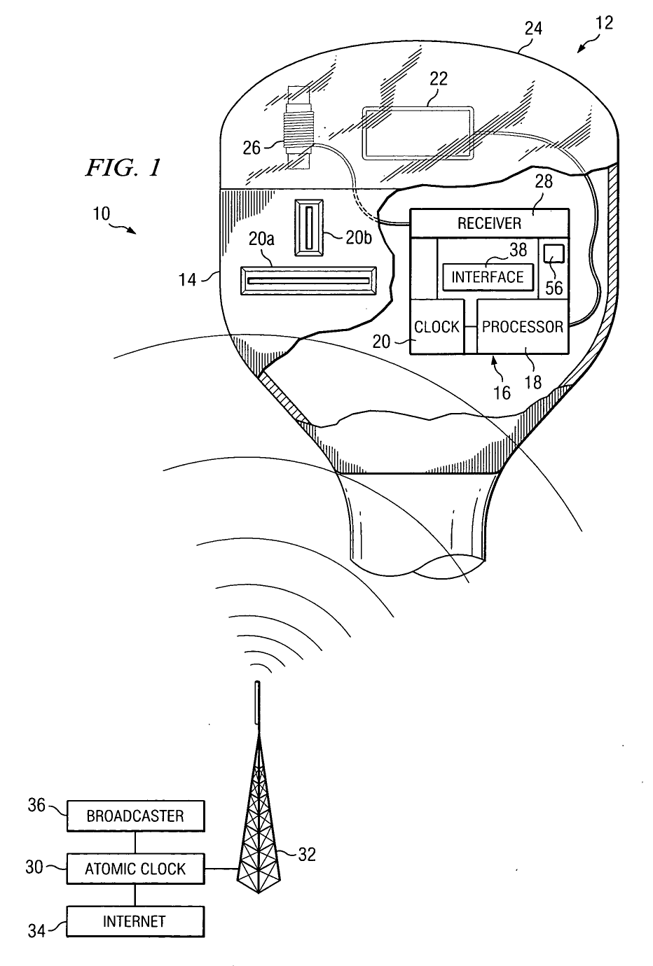

FIG. 1 illustrates one aspect of a system 10 for synchronizing a parking meter clock. The system 10 includes a parking meter 12, which may be an electronic parking meter, having a housing 14 that is illustrated in FIG. 1 in a partial cutaway view. The parking meter 12 includes a circuit board 16 coupled to the parking meter 12. In this aspect, a processor 18 is provided on the circuit board 16 to process information related to the parking meter 12. A clock 20 is provided on the circuit board 16, according to one aspect, while in other aspects the clock 20 may be incorporated, included or otherwise integrated into the processor 18 or a plurality of clocks may be employed. The clock 20 is operable to maintain real time information related to the date and time of day. The processor 18, according to one aspect, is in communication with the clock 20 for providing information to the clock and receiving time-related information from the clock 20. The processor 18 is in communication with a display 22, such as an LED or LCD display for providing parking related information to the user of the parking meter 12. A transparent portion 24 encloses the display and is coupled to the housing 14 to protect the display from damage and the elements.

The parking meter 12 further includes a payment slot 20a provided on the front of the housing 14 for receiving smart cards, credit cards, or other payment devices. In other aspects, a payment slot 20b is also provided to receive coins or tokens for payment for parking. In other aspects, the payment slot 20a and 20b are both provided, or either may be utilized.

The present invention, according to one aspect, includes an antenna 26 in communication with a receiver 28, which is provided on the circuit board 16 in this aspect. The antenna 26 is operable to receive a signal, such as, but not limited to, an AM and/or FM radio signal, VHF television signal or other wireless communications. The antenna communicates the signal to the receiver 28 to demodulate the signal based on the carrier. The receiver 28 is operable to demodulate the amplitude of an AM signal or, in other aspects, the frequency of an FM signal, for example. Although the receiver 28 is shown provided on the circuit board 16, in other aspects, the receiver 28 may be provided on a separate circuit board, or otherwise in communication with the antenna 26 and processor 18. According to one aspect, the receiver 28 is an AM receiver to receive time signals in a frequency range of from 40 kHz to about 100 kHz and includes an automatic gain control amplifier in communication with demodulator and comparator circuitry, such as the AM Receiver IC Model No. MAS9078 available from Micro Analog Systems.

According to one aspect, the parking meter 12 of the present invention is adapted to receive a time signal, such as from an atomic clock 30. The National Institute of Standards (NIST) maintains a radio station, WWVB, which receives highly-accurate time information from an atomic clock and transmits a time signal information via a radio broadcast system 32. The information from an atomic clock is also provided and available via the Internet 34 by wireless network connection by the parking meter 12 to the Internet 34.

Other broadcasters 36, such as television signals transmitted on the VHF band, frequently include a time reference signal including time that may be based on an atomic clock 30. According to one aspect, the atomic clock 30 generates an accurate time measurement, which is communicated to the radio broadcast system 32 for transmission. The resulting AM signal transmitted is based on the time generated by the atomic clock 30. The parking meter 12 of the present invention is operable to receive the AM signal via the antenna 26 and communicate the signal to the receiver 28.

The receiver 28 is operable to demodulate the signal received from the radio broadcast 32 and communicate a time information to the processor 18 and/or the clock 20. The time information is utilized by the present invention to synchronize the clock on the parking meter in response to receiving the time signal from the radio broadcast system 32. According to one aspect, the parking meter 12 may include an interface 38 coupled to communicate the time signal data to the clock 20. The interface 38 may include programming or instruction to promote synchronization of the clock with the wirelessly received time based signal. According to one aspect, the time signal generated by the radio broadcast system 32 may include, but is not limited to, a date and time information.

The parking meter 12 of the present invention may be advantageously employed for synchronizing the clock 20 on the parking meter 12 to overcome the disadvantages of prior time keeping systems. According to one aspect, the processor 18 may be programmed to initiate reception of the time signal by the receiver 28 and updating or synchronizing the clock 20 to the time signal, which is based on the atomic clock 30. The time information is useful to the parking meter 12 to determine the timing of certain events, including, but not limited to, reduced power, sleep, parking rates and modes, or other parking meter 12 functionality, which will readily suggest themselves to one of ordinary skill in the art and is within the spirit and scope of the present invention.

Frequently, a plurality of parking meters 12 are employed at certain locations and the present invention enables a plurality of parking meters 12 to maintain accurate and synchronized time information avoiding significant problems, such as incorrect rate and credit for the purchase of parking time due to inaccurate time information. Utilizing the present invention significantly reduces frustration, inaccuracies, and inefficiencies related to inaccurate time and date information caused by prior parking meter systems.

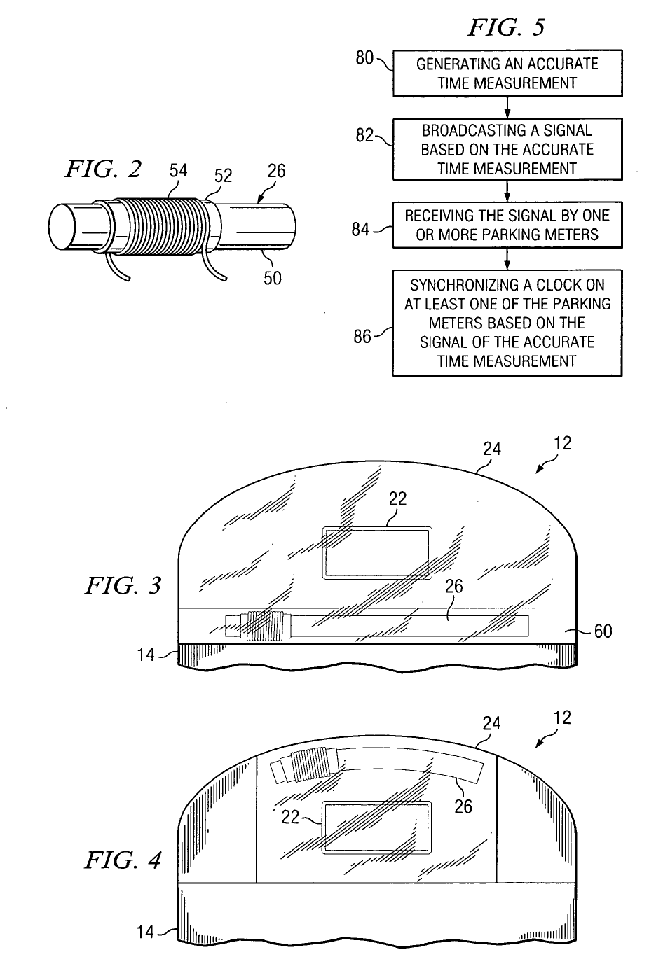

FIG. 2 illustrates a perspective view of one aspect of the antenna 26 of the present invention. To receive a broadcast from the NIST radio station, WWVB, transmitting atomic clock information on the AM band, the antenna 26 of the present invention, according to one aspect, is a ferrite antenna as illustrated in FIG. 2. A ferrite antenna 26 includes a shaft 50 constructed of a metallic material, such as ferrite. The shaft 50 is provided with an insulating material 52 to provide insulation between the shaft 50 and coiled wire 54 encircling the shaft 50.

The coiled wire 54 communicates the AM signal to the receiver 28, according to one aspect. In other aspects, other antennas may be provided, in addition to or instead of the ferrite antenna 26 illustrated in FIG. 2. For example, where the time signal is received as a time reference from the VHF band of a television signal, an appropriate antenna will be provided, which is well known to one of ordinary skill in the art and, for sake of brevity, will not be discussed or described herein. In other aspects, the antenna 26 may be a trace 56 printed on the circuit board 16 (see FIG. 1), and in other aspects other antennas may be utilized, which are well known in the art and within the spirit and scope of the present invention.

FIG. 3 illustrates another aspect of the present invention of the parking meter 12 wherein the antenna 26 is shown centrally disposed in a recess 60 in the housing 14. In this aspect, the antenna 26, such as the ferrite antenna 26 illustrated in FIG. 2, may be provided with a clear plastic or polymeric material covering the antenna to protect the antenna from wear, abuse, or the elements, but promoting signal reception. In other aspects, the antenna 26 may be encased in polymeric material and similarly coupled to the housing 14 as shown.

Referring also to FIG. 4, in some aspects it may be advantageous to locate the antenna 26 near the top or a higher point of the parking meter 12 to improve reception of the time signal. In this aspect, the antenna 26 may be provided in an upper part of the housing 14 of the parking meter 12. As illustrated in FIG. 1, a transparent portion 24, hood or other upper portion of the housing 14 of the parking meter 12 may be integrated into or provided to retain the antenna 26 for improved signal reception.

Where the upper portion of the housing 14 is a transparent portion 24, the antenna 26 may be provided adjacent the transparent portion 24 of the parking meter 12. It will be appreciated that a number of antenna 26 of various configurations for each type of antenna, as well as positioning and location of the antenna 26 in the parking meter 12 may be suitable for these purposes and will readily suggest themselves to one of ordinary skill in the art based on the present disclosure.

FIG. 5 is a flow chart illustrating a method for synchronizing clocks 20 on parking meters 12, according to one aspect of the present invention. The method includes, at a block 80, generating an accurate time measurement, such as by utilizing an atomic clock 30 or accurate time measurement device. At a block 82, the method includes broadcasting a signal including the accurate time measurement. The broadcast may include transmission to the Internet for broadcast on a WiFi network, AM, FM, VHF, cellular or digital or other known or hereafter developed systems for wirelessly broadcasting or transmitting information and/or data. The signal, such as for a VHF television broadcast, may be a time reference, or an AM time and frequency signal for AM transmission, for example.

At a block 84, the method includes receiving the signal by one or more parking meters 12. As previously discussed, the parking meters 12 may include the clock 20, the antenna 26 for receiving the signal, the receiver 28 to demodulate the signal.

At a block 86, the method includes synchronizing the clock 20 on at least one of the parking meters 12 based on the signal including the accurate time measurement. According to one aspect, the processor 18 and/or the interface 38 communicates with the receiver 28 for the clock to synchronize time and date information based on the signal including the accurate time measurement.

Although the preferred embodiment has been described in detail, it should be understood that various changes, substitutions, and alterations can be made herein without departing from the scope of the present invention, even if all of the advantages identified above are not present. For example, the various embodiments shown in the drawings herein illustrate that the present invention may be implemented and embodied in a variety of different ways that still fall within the scope of the present invention.

Although the techniques, designs, elements, and methods described and illustrated in the embodiments as discrete or separate may be combined or integrated with other techniques, designs, elements, or methods without departing from the scope of the present invention. Other examples of changes, substitutions, and alterations are readily ascertainable by one skilled in the art and could be made without departing from the spirit and scope of the present invention.

What is claimed is:

1. A parking meter, comprising:
a processor to process parking related information;
a clock in communication with the processor;
an antenna coupled to the parking meter for receiving a wireless broadcast data;
a receiver communicating with the antenna to demodulate the wireless broadcast data received by the antenna; and
an interface communicating with the receiver to communicate the wireless broadcast data.

2. The parking meter of claim 1, wherein the antenna is further defined as a ferrite antenna.

3. The parking meter of claim 1, wherein the parking meter is further provided with a printed circuit board coupled to the parking meter and wherein the antenna is further defined as a trace on the printed circuit board.

4. The parking meter of claim 1, wherein the wireless broadcast data is further defined as an AM signal and the receiver is further defined an integrated circuit for receiving the AM signal.

5. The parking meter of claim 1, wherein the wireless broadcast data includes a time data related to a current time-of-day.

6. The parking meter of claim 5, wherein the processor is operative to synchronize the clock based on the time data in response to receiving the wireless broadcast data.

7. A method of synchronizing a clock on a parking meter, comprising:
receiving a wirelessly broadcast data that includes a time-of-day data; and
updating the clock on the parking meter based on the wirelessly broadcast data.

8. The method of claim 7, wherein the time-of-day data is based on an atomic clock.

9. The method of claim 7, wherein the time-of-day data is based on a time reference generated by a television signal.

10. The method of claim 7, wherein the wirelessly broadcast data is further defined as a wireless internet connection and wherein the time-of-day data is further defined as a time reference based on a standard time measurement device.

11. The method of claim 10, wherein the standard time measurement device is an atomic clock.

12. A method of synchronizing time circuits on a plurality of parking meters, comprising:
broadcasting a time signal including a time-of-day data;
receiving the time signal by a plurality of parking meters; and
synchronizing a clock on at least one of the plurality of parking meters based on the time signal.

13. The method of claim 12, wherein the time-of-day data is based on an atomic clock.

14. The method of claim 12, wherein the time-of-day data is based on a time reference generated by a television signal.

15. The method of claim 12, wherein the method further includes establishing a wireless internet connection.

16. The method of claim 15, wherein the time-of-day data is based on an atomic clock.

17. A parking meter, comprising:
a housing;
a payment slot coupled to the housing to receive payment for parking;
a processor in communication with the payment slot;
a display communicating with the processor to display a parking information based on payment received via the payment slot;
a clock communicating with the processor, the clock to maintain a time information for use by the parking meter;
an antenna to receive a wireless broadcast time data;
a receiver to demodulate the wireless broadcast time data; and
an interface coupled to communicate the wireless broadcast time data to the clock.

18. The parking meter of claim 17, wherein the processor is operative to synchronize the time information maintained by the clock based on the wireless broadcast time data.

19. The parking meter of claim 18, wherein the clock is a real-time clock.

20. The parking meter of claim 17, wherein the wireless broadcast time data is further defined as an AM signal with a time information based on a standard time measurement device.

21. The parking meter of claim 20, wherein the standard time measurement device is an atomic clock.

22. The parking meter of claim 17, wherein the wireless broadcast time data is further defined as a time reference generated by a television signal.

23. The parking meter of claim 17, wherein the wireless broadcast time data is further defined as a wireless Internet connection providing a time reference.

24. The parking meter of claim 23, wherein the time reference is based on an atomic clock.

25. The parking meter of claim 17, wherein the payment receiving slot is further defined as card reader to receive a smart card.

26. The parking meter of claim 17, wherein the payment receiving slot is further defined as card reader to receive a credit card.

27. The parking meter of claim 17, wherein payment slot is further defined as a coin chute for receiving coins and wherein the parking meter further includes a coin box coupled to the coin chute.
